(19) United States
(12) Patent Application Publication
(10) Pub. No.: US 2011/0267306 A1
(43) Pub. Date: Nov. 3, 2011

(54) ELECTRONIC READING APPARATUS AND THE NOTE RECORDING METHOD THEREOF

(75) Inventors: YUNG-SHENG CHANG, HSINCHU CITY (TW); SUNG-HUI HUANG, HSINCHU CITY (TW); CHIN-WEN LIN, HSINCHU CITY (TW); TED-HONG SHINN, HSINCHU CITY (TW)

(73) Assignee: E INK HOLDINGS INC., HSINCHU CITY (TW)

(21) Appl. No.: 12/840,546

(22) Filed: Jul. 21, 2010

(30) Foreign Application Priority Data
May 3, 2010 (TW) 99114037

(51) Int. Cl. G06F 3/045

(52) U.S. Cl. 345/174

(57) ABSTRACT

An electronic reading apparatus includes a cover, a writing portion and a displaying portion. The cover defines a first side and a second side. The writing portion is arranged at the first side of the cover, and includes a touch input device and a writing unit. The writing unit is configured to create a content of a note by receiving inputs for the content of the note, and the touch input device detects a touch signal for generating an electronic note file in accordance with the touch signal. The displaying portion is arranged at the second side of the cover; and includes a first display unit for displaying a first content.

### BACKGROUND OF THE INVENTION

1. Field of the Invention

The present invention relates to an electronic reading apparatus; in particular, to an electronic reading apparatus, which is able to record the contents of a note.

2. Description of Related Art

As electronic papers are associated with characteristics of low power consumption, compact in size, and flexibility, the display devices devoted to the electronic papers gradually gain their popularity. The applications of the electronic paper cover smart cards, e-labels, e-Books, mobile phones, notebooks, car displays, and even commercial digital boards. The currently existing electronic paper has been much more flexible in nature and thus is capable of being incorporated into people's daily lives without too much difficulty. Among the applications of the electronic paper technology, the electronic reading apparatus is the most popular and widely accepted, and may be in line to replace the traditional papers.

Though there are lots of advantages of the electronic reading apparatus, the functions thereof are still not able to fulfill the reading and studying needs for users. For example, taking notes after reading through materials may be necessary though the conventional electronic reading apparatus fails to provide such particular functionality.

### SUMMARY OF THE INVENTION

The object of the present invention is to disclose an electronic reading apparatus that is capable of offering the note-taking functionality. Thus, human operators may take notes when reading through the materials with the electronic reading apparatus according to the present invention. More specifically, the human operators may take notes by writing down the content of the note on the paper sheets or employing an electromagnetic pen.

In order to achieve the aforementioned objects, according to an embodiment of the present invention, an electronic reading apparatus includes a cover, a writing portion and a displaying portion. The cover defines a first side and a second side. The writing portion is arranged at the first side of the cover, and includes a touch input device and a writing unit. The writing unit may serve as an input device for receiving the content of the note, and the touch input device detects a touch signal associated with the received input before an electronic note file corresponding to the touch signal could be generated. The displaying portion is arranged at the second side of the cover; and includes a first display unit for displaying a first content.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

In order to further the understanding regarding the present invention, the following embodiments are provided along with illustrations to facilitate the disclosure of the present invention.

### BRIEF DESCRIPTION OF THE DRAWINGS

FIGS. 1A and 1B respectively show a perspective view and a cross-sectional profile of an electronic reading apparatus in accordance with one embodiment according to the present invention;

FIG. 2 shows a perspective view of a electromagnetic pen in accordance with the one embodiment according to the present invention;

FIGS. 3A and 3B respectively show a perspective view and a cross-sectional profile of the electronic reading apparatus in accordance with one embodiment according to the present invention; and

FIG. 4 shows a flow chart of an operation method for the electronic reading apparatus in accordance with one embodiment according to the present invention.

### DETAILED DESCRIPTION OF THE PREFERRED EMBODIMENTS

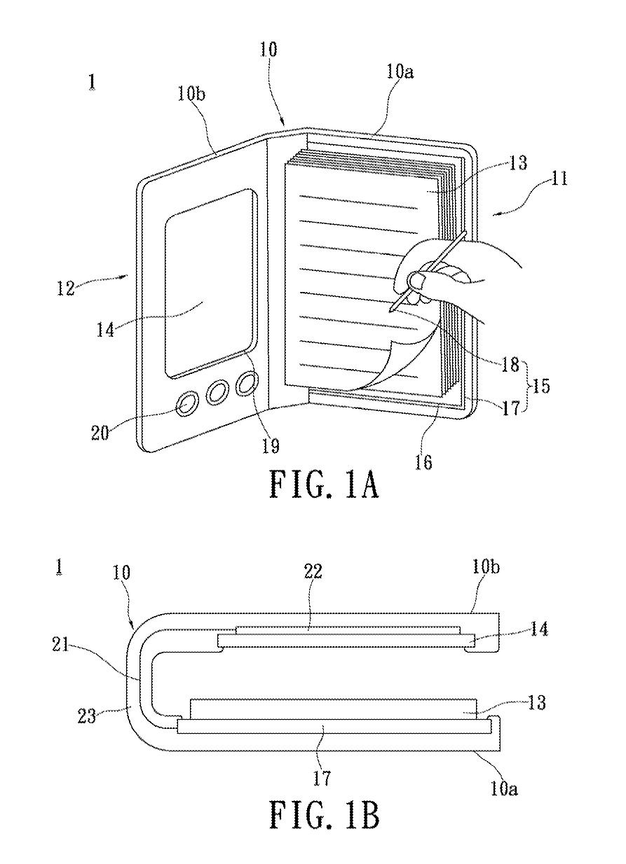

Referring now to FIGS. 1A and 1B, in which an electronic reading apparatus in accordance with one embodiment according to the present invention is disclosed. The electronic reading apparatus 1 includes a cover 10, a writing portion 11 and a displaying portion 12.

The cover 10 defines a first side 10a and a second side 10b. The writing portion 11 is arranged at the first side 10a of the cover 10, and the displaying portion 12 is arranged at the second side 10b of the cover 10.

The first side 10a has a hollow portion 16 for receiving a digital sensor board 17. In front of the digital sensor board 17, a writing unit 13, which includes multiple paper sheets or a sketch book, is arranged. An electromagnetic pen 18 along with the digital sensor board 17 serve as a touch input device 15, which receives inputs from users.

The second side 10b includes another hollow portion 19 for receiving a first display unit 14 and a driving circuit 22. The displaying portion 12 further includes a plurality of first control keystrokes 20 arranged below the first display unit 14. The first control keystrokes 20 may protrude out of the surface of the second side 10b or be placed inside of the second side 10b. The first control keystrokes 20 are used for controlling contents to be shown on a display panel 14, for saving or accessing an electronic note file, and for operating the electronic reading apparatus 1, such as switching, turning pages, controlling the sound volume.

Besides, the cover 10 further includes a connection portion 23 in which a signal line 21 is accommodated so that the digital sensor board 17 at the first side 10a and the driving circuit 22 at the second side 10b may communicate. It is worth noting that the driving circuit 22 could be arranged at the first side 10 even with the connection portion 23.

The cover 10 is foldable to enclose the writing portion 11 and the displaying portion 12 therein for protection.

The first display unit 14 could be the display panel of any commercially available display technology. In the current embodiment, the first display unit 14 is a display panel corresponding to the application of electronic paper technology, so as to be more power efficient and more compact in size, and to offer readers the experience of as if they still read a paper.

The touch input device 15 is a touch panel with an electromagnetic touch control technology incorporated, which may include the digital sensor board 17 and the electromagnetic pen 18. In the electromagnetic touch control technology, the electromagnetic pen 18 is configured to emit a signal. And when the electromagnetic pen 18 approaches the digital sensor board 17, the magnetic field has been changed accordingly for the positioning of a contact point. A touch signal is generated thereby and transmitted to the driving circuit 22 via the signal line 21. The touch signal will be recognized by the driving circuit 22 and then stored in the driving circuit 22.

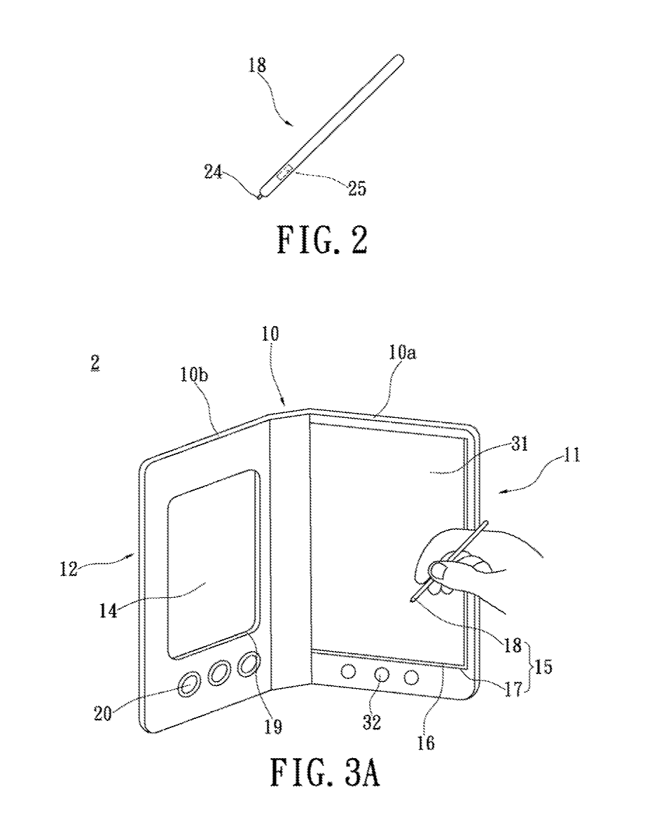

FIG. 2 is a perspective view of an electromagnetic pen in accordance with one embodiment according to the present invention diagram.

The electromagnetic pen 18 includes an electromagnetic emission module 25 and a tip 24 disposed at one end of the emission module 18. The tip 24 could be a pencil tip or a ballpoint pen tip. The user can write or draw on the paper sheets of the writing unit 13. At the same time, the electromagnetic effect between the electromagnetic emission module 25 of the electromagnetic pen 18 and the digital sensor board 17 caused by the movement of the movement of the electromagnetic pen 18 may be detected for the generation of the corresponding touch signal.

When the user flips open the electronic reading apparatus 1, the electronic reading apparatus 1 is switched on or off via the first control keystrokes 20. As previously discussed, the first control strokes 20 may be configured to control the display content of the first display unit 14.

When the electronic reading apparatus 1 is in use the paper sheets of the writing unit 13 may receive inputs from the electromagnetic pen 18. As the touch signal corresponding to the inputs may be generated as the result of the electromagnetic effect associated with the electromagnetic pen 18 and the digital sensor board 17 and recognized by the driving circuit 22, such inputs may be stored into a memory unit (not shown) of the driving circuit 22 for the generation of the electronic note file. The content of the electronic note file may be accessed and displayed on the first display unit 14.

The electronic reading apparatus 1 according to the embodiment is equipped with the writing portion 11 and the displaying portion 12. The first display unit 14 of the displaying portion 12 may display a first content, which might be different to the content of the electronic note file. Therefore, the first content may correspond to the materials studied or to be studied by the human operators. In another implementation, the preparation of the electronic note file via the writing unit 13 (or the input of the content of the electronic note file) may be shown on the first display unit 14 when the input of the content of the electronic note file is received.

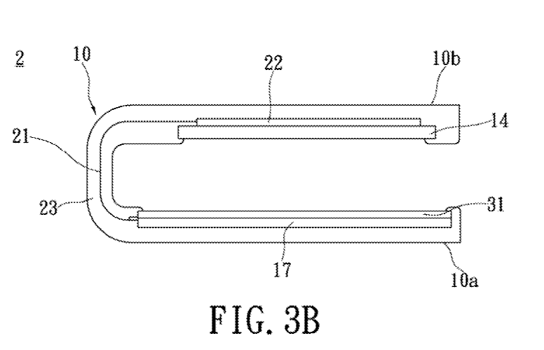

Referring now to FIGS. 3A and 3B, in which an electronic reading apparatus 2 in accordance with one embodiment according to the present invention is disclosed. The structure of the electronic reading apparatus 2 is similar to that of the electronic reading apparatus 1. The differences are: the writing unit 13 of the first side 10a of the cover 10 of the electronic reading apparatus 1 is replaced by a second display unit 31 in the electronic reading apparatus 2. The second display unit 31 connects with the driving circuit 22 and is controlled by the driving circuit 22 to show images. A plurality of the second control keystrokes 32 are arranged below the second display unit 31. The second control keystrokes 32 could protrude out of the surface of the first side 10a or be arranged therein. The second control keystrokes 32 are used for saving or storing an electronic note file, and for operating the electronic reading apparatus 2, such as switching on/off of the electronic reading apparatus 2, turning pages of the content of the electronic note file, controlling the volume of the electronic reading apparatus 2. In the current embodiment, the second display unit 31 is a cholesteric reflective display.

When the input is received by the writing/drawing on the second display unit 31 via the electromagnetic pen 18, the corresponding touch signal is generated in response to the movement of the electromagnetic pen 18 and then stored in the driving circuit 22 before the electronic note file is generated. The driving circuit 22 may be configured to display the movement of the electromagnetic pen 18 on the second display unit 31 so that what is inputted associated with the movement of the electromagnetic pen 18 may be demonstrated.

The second control keystrokes 32 may control the display of the contents shown on the second display unit 31. For example, the input could be stored via the second control keystrokes 32 for the preparation/generation of the electronic note file via the driving circuit 22. The electronic note file stored in the memory unit of (not shown) the driving circuit 22 may be accessed by the second control keystrokes 32, and displayed on the second display unit 31. The second control keystrokes 32 may clear the contents displayed on the second display unit for another input of another electronic note file to be displayed.

The second display unit, in other cases, could be an LCD panel, an OLED panel or an electronic paper.

The touch input device 15, in other cases, could be an electromagnetic sensor panel, a resistive touch panel, a capacitive touch panel or a pressure sensor panel.

When the touch input device 15 is a resistive touch panel or a pressure sensor panel, the electromagnetic pen 18 may be substituted with an ordinary ballpoint pen or pencil. When the touch input device 15 is a capacitive touch panel, human fingers or metallic pen may be used to provide the input of the electronic note file. Besides, the resistive touch panel may be a four-wire resistive sensor plate while the pressure sensor panel may be equipped with four pressure sensors.

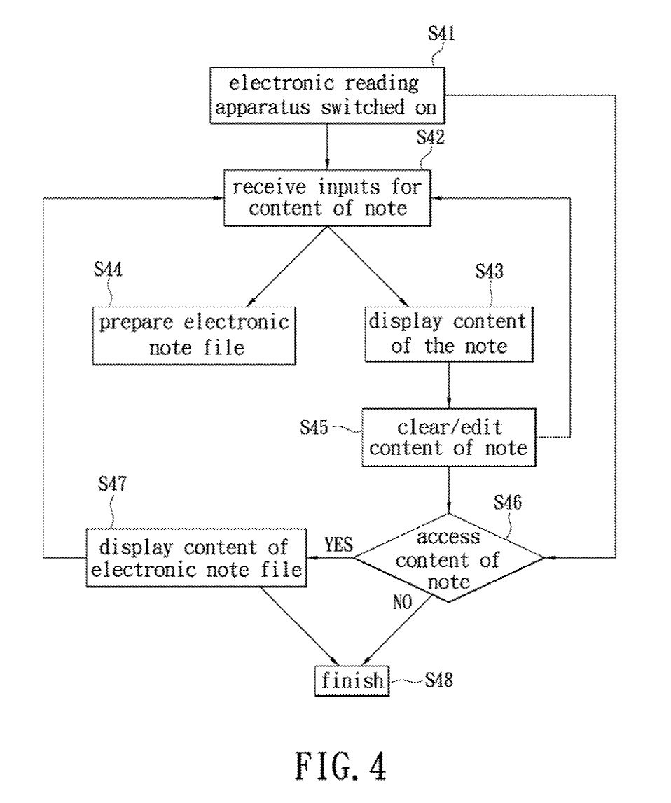

In conjunction with FIGS. 1A-1B, and 3A-3B, FIG. 4 is a flow chart of an operation method for an electronic reading apparatus according to one embodiment of the present invention.

The electronic reading apparatus 1 or 2 is switched on in step S41 and a first content may be displayed on a displaying portion 12 of the electronic reading apparatus 1. The first content may correspond to the materials studied or to be studied by the human operators. In step S42, the electronic reading apparatus receives inputs via the electromagnetic pen 18 and the writing portion 11. The content of the note may be shown on the second display unit 31 in step S43. The touch input device 15 detects the movement of the electromagnetic pen 18 to generate the touch signal and save it into the memory of the driving circuit 22 so as to generate/prepare the electronic note file in a step S44.

The paper sheets in the electronic reading apparatus 1 may be removed manually while the content of the note displayed on the second display unit of the electronic reading apparatus 2 may be erased or updated by the second control keystrokes 32, as shown in step S45. The steps S42 to S45 could be repeated to prepare different electronic note files.

The content of note may be reviewed upon the preparation thereof is complete (step S46). For example, the content of the note may be accessed by and displayed on the first display unit 14 or the second display unit 31 via the operations of the first control keystrokes 20 or the second control keystrokes 32. While no review of the content of the prepared note, the electronic reading apparatus 1 or 2 may be switched off directly.

If the user wants to edit the content of the note, the updated may be received on the writing portion 11 and the steps of S42 to S45 may be repeated until the entire update of the content of the note is accomplished. Thereafter, the electronic reading apparatus 1 or 2 may be switched off (step S48).

After the electronic reading apparatus 1 or 2 is switched on, the content of the note may be reviewed without the electronic reading apparatus 1 or 2 going through the steps S42-S45. The content of the note may be accessed (step S46) and the content of the electronic note file may be displayed on the first display unit 14 or the second display unit 31 (step S47). Thereafter, the content of the note may be edited with the electronic reading apparatus going through the steps S42 to S45. The electronic reading apparatus 1 or 2 may be switched off without any modification to the currently existing content of the note (step S48).

The above-mentioned descriptions represent merely the embodiments of the present invention, without any intention to limit the scope of the present invention thereto. Various equivalent changes, alternations or modifications based on the claims of present invention are all consequently viewed as being embraced by the scope of the present invention.

What is claimed is:

1. An electronic reading apparatus comprising:
a cover defining a first side and a second side;
a writing portion arranged at the first side of the cover including a touch input device for generating a touch signal before further generating an electronic note file in accordance with the touch signal, and a writing unit for creating a content of a note wherein a content of the electronic note file corresponds to the content of the note; and
a displaying portion arranged at the second side of the cover including a first display unit for displaying a first content.

2. The electronic reading apparatus according to claim 1, wherein the touch input device is selected from an electromagnetic sensor panel, a resistive touch panel, a capacitive touch panel and a pressure sensor panel, the writing unit is a combination of multiple paper sheets, and the touch input device includes an electromagnetic pen and a digital sensor board, when the touch input device is the electromagnetic sensor panel.

3. The electronic reading apparatus according to claim 1, further including a driving circuit connecting the first display unit and the touch input device wherein the driving circuit is for controlling the first display unit to display the first content and the content of the note, and for receiving and saving the touch signal so as to prepare the electronic note file with a content thereof the same as the content of the note.

4. An electronic reading apparatus comprising:
a cover defining a first side and a second side;
a writing portion arranged at the first side of the cover including a touch input device for detecting a touch signal before generating an electronic note file in accordance with the touch signal and a second display unit for displaying a content of a note; and
a displaying portion arranged at the second side of the cover including a first display unit for displaying a first content.

5. The electronic reading apparatus according to claim 4, wherein the touch input device is selected from an electromagnetic sensor panel, a resistive touch panel, a capacitive touch panel and a pressure sensor panel, the second display unit is selected from a cholesteric reflective display, an LCD panel, an OLED panel and an electronic paper, and the touch input device includes an electromagnetic pen and a digital sensor board when the touch input device is the electromagnetic sensor panel.

6. The electronic reading apparatus according to claim 4, further including a driving circuit connecting the first display unit, the second display unit and the touch input device wherein the driving circuit is for controlling the first display unit to display the first content and the content of the note, receiving and saving the touch signal so as to generate the electronic note file with a content the as same as the content of the note, and displaying the electronic note file on the second display unit.

7. A note recording method of an electronic reading apparatus, comprising:
displaying on a displaying portion of the electronic reading apparatus;
receiving a content of a note in a writing portion of the electronic reading apparatus;
displaying the content of the note; and
preparing a touch signal in accordance with the content of the note received via a touch input device of the writing portion, and generating an electronic note file after storing the touch signal in a driving circuit.

8. The note recording method according to claim 7, wherein the touch input device is selected from an electromagnetic sensor panel, a resistive touch panel, a capacitive touch panel and a pressure sensor panel, the touch input device includes an electromagnetic pen and a digital sensor board when the touch input device is the electromagnetic sensor panel, the writing portion displays the content of the note via one of a second display unit and a writing unit with the second display unit selected from a cholesteric reflective display, an LCD panel, an OLED panel and an electronic paper, and the writing unit is a combination of multiple paper sheets.

9. The note recording method according to claim 7, further including a step of connecting a driving circuit with the first display unit and the touch input device, wherein the driving circuit is used for controlling the first display unit to display the content of the note, and receiving and storing the touch signal so as to generate the electronic note file with a content the same as the content of the note.

10. The note recording method according to claim 7, wherein the electronic reading apparatus further includes:
a cover defining a first side and a second side;
a writing portion arranged at the first side of the cover; and
a displaying portion arranged at the second side of the cover.
